(19) United States
(12) Patent Application Publication
(10) Pub. No.: US 2024/0301714 A1
(43) Pub. Date: Sep. 12, 2024

(54) SHELTER APPARATUS AND METHOD THEREOF

(71) Applicant: Gilbert Bernard, SYDNEY (CA)

(72) Inventor: Gilbert Bernard, SYDNEY (CA)

(21) Appl. No.: 18/599,093

(22) Filed: Mar. 7, 2024

Related U.S. Application Data
(60) Provisional application No. 63/488,768, filed on Mar. 7, 2023.

(51) Int. Cl. E04H 9/14; E06B 9/00

(52) U.S. Cl. CPC E04H 9/14; E06B 9/00; E06B 2009/005

(57) ABSTRACT

A storm shelter apparatus that can be coupled to the ground. The storm shelter can be comprised of a plurality of building sections. Each of the building sections can include a frame portion and an exterior panel portion. The frame portion can be comprised of a plurality of support sections comprised of support members. The support sections can be triangular support sections. The triangular support section can be coupled to one another using any suitable means. The exterior panel portion can be comprised of a singular exterior panel formed to encompass the entire apparatus, a singular structure formed to encompass the entire building section, or a panel formed to correspond to each of the support sections.

### CROSS-REFERENCE TO RELATED APPLICATION

This U.S. patent application claims priority to U.S. Provisional Application 63/488,768 filed Mar. 7, 2023, the disclosure of which is considered part of the disclosure of this application and is hereby incorporated by reference in its entirety.

### FIELD OF THE INVENTION

The invention relates generally to a protective shelter structure. More particularly the invention relates to a structure in the form of cage like device for the protection of an interior area during an extreme wind or weather event such as a tornado.

### BACKGROUND

During severe weather events that generate extreme winds individuals are directed to secure protected areas. Generally, these protected areas are located underground in a basement, cellar, or dedicated storm shelter. When these underground locations are not available, individuals are directed to use structurally sound interior rooms, but this solution may be unable to meet the needs of the market because it may not be available or may not be the safest option.

There exists a need for a protective structure that can be easily assembled by a user to product users from a strong wind. Furthermore, it would also be advantageous to have an apparatus that allows for easy setup. Still further, it would be advantageous to have an apparatus that can be easily and quickly accessed during an emergency. Therefore, there currently exists a need in the market for a dedicated structural apparatus that can provide protection from tornados.

### BRIEF SUMMARY OF THE INVENTION

In one aspect, the present disclosure relates to a storm shelter apparatus that can be coupled to the ground. The storm shelter can be comprised of a plurality of building sections. Each of the building sections can include a frame portion and an exterior panel portion. The frame portion can be comprised of a plurality of support sections comprised of support members. In some exemplary embodiments, the support sections can be triangular support sections. The triangular support section can be coupled to one another using any suitable means. The exterior panel portion can be comprised of a singular exterior panel formed to encompass the entire apparatus, a singular structure formed to encompass the entire building section, or a panel formed to correspond to each of the support sections. The frame portion of the building sections can include one or more mounting points to couple the plurality of building section to one anther as well as couple the apparatus to the ground or foundation. One of the building sections can include a pivotable door hingedly coupled to the building portion. The door can be moved from a first position to a second position. The door can similarly be constructed of one or more support sections and form a structural component of the building section.

In one another aspect, the present disclosure relates to an above ground or in-home shelter, which can withstand tornado-like conditions. An apparatus of the present disclosure can comprise a cage-like assembly specifically configured for protective use during tornado-like conditions. The apparatus provides protection to an interior area and the occupants from tornado-like conditions. The apparatus can be set up easily and fulfills the needs of providing shelter during a tornado. Among other things, it is an advantage of the invention to provide a tornado safety cage/structure that does not suffer from any of the problems or deficiencies associated with prior solutions.

In another aspect, the present disclosure relates to a building system for constructing a storm shelter comprising a plurality of building sections, wherein the building sections can be constructed in separate sections easy for transport that can be assembled on location.

The invention now will be described more fully hereinafter with reference to the accompanying drawings, which are intended to be read in conjunction with both this summary, the detailed description and any preferred and/or particular embodiments specifically discussed or otherwise disclosed. This invention may, however, be embodied in many different forms and should not be construed as limited to the embodiments set forth herein; rather, these embodiments are provided by way of illustration only and so that this disclosure will be thorough, complete and will fully convey the full scope of the invention to those skilled in the art.

### BRIEF DESCRIPTION OF THE DRAWINGS

FIG. 1 is a front perspective view of an exemplary embodiment of a shelter apparatus of the present disclosure.

FIG. 2 is a side perspective view of an exemplary embodiment of a shelter apparatus of the present disclosure.

FIG. 3 is top perspective view of an exemplary embodiment of a shelter apparatus of the present disclosure.

FIG. 4 is a bottom perspective view of an exemplary embodiment of a shelter apparatus of the present disclosure.

FIG. 5 is a perspective view of a building section of an exemplary embodiment of a shelter apparatus of the present disclosure.

FIG. 6 is a top perspective view of an exemplary embodiment of a shelter apparatus of the present disclosure illustrating a plurality of building sections of the apparatus.

### DETAILED DESCRIPTION OF THE INVENTION

The following detailed description includes references to the accompanying drawings, which forms a part of the detailed description. The drawings show, by way of illustration, specific embodiments in which the invention may be practiced. These embodiments, which are also referred to herein as “examples,” are described in enough detail to enable those skilled in the art to practice the invention. The embodiments may be combined, other embodiments may be utilized, or structural, and logical changes may be made without departing from the scope of the present invention. The following detailed description is, therefore, not to be taken in a limiting sense.

Before the present invention of this disclosure is described in such detail, however, it is to be understood that this invention is not limited to particular variations set forth and may, of course, vary. Various changes may be made to the invention described and equivalents may be substituted without departing from the true spirit and scope of the invention. In addition, many modifications may be made to adapt a particular situation, material, composition of matter, process, process act(s) or step(s), to the objective(s), spirit or scope of the present invention. All such modifications are intended to be within the scope of the disclosure made herein.

Unless otherwise indicated, the words and phrases presented in this document have their ordinary meanings to one of skill in the art. Such ordinary meanings can be obtained by reference to their use in the art and by reference to general and scientific dictionaries.

References in the specification to “one embodiment” indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

The following explanations of certain terms are meant to be illustrative rather than exhaustive. These terms have their ordinary meanings given by usage in the art and in addition include the following explanations.

As used herein, the term “and/or” refers to any one of the items, any combination of the items, or all of the items with which this term is associated.

As used herein, the singular forms “a,” “an,” and “the” include plural reference unless the context clearly dictates otherwise.

As used herein, the terms “include,” “for example,” “such as,” and the like are used illustratively and are not intended to limit the present invention.

As used herein, the terms “preferred” and “preferably” refer to embodiments of the invention that may afford certain benefits, under certain circumstances. However, other embodiments may also be preferred, under the same or other circumstances.

Furthermore, the recitation of one or more preferred embodiments does not imply that other embodiments are not useful and is not intended to exclude other embodiments from the scope of the invention.

As used herein, the terms “front,” “back,” “rear,” “upper,” “lower,” “right,” and “left” in this description are merely used to identify the various elements as they are oriented in the FIGS, with “front,” “back,” and “rear” being relative to the apparatus. These terms are not meant to limit the elements that they describe, as the various elements may be oriented differently in various applications.

As used herein, the term “coupled” means the joining of two members directly or indirectly to one another. Such joining may be stationary in nature or movable in nature. Such joining may be achieved with the two members or the two members and any additional intermediate members being integrally formed as a single unitary body with one another or with the two members or the two members and any additional intermediate members being attached to one another. Such joining may be permanent in nature or alternatively may be removable or releasable in nature. Similarly, coupled can refer to a two member or elements being in communicatively coupled, wherein the two elements may be electronically, through various means, such as a metallic wire, wireless network, optical fiber, or other medium and methods.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element without departing from the teachings of the disclosure.

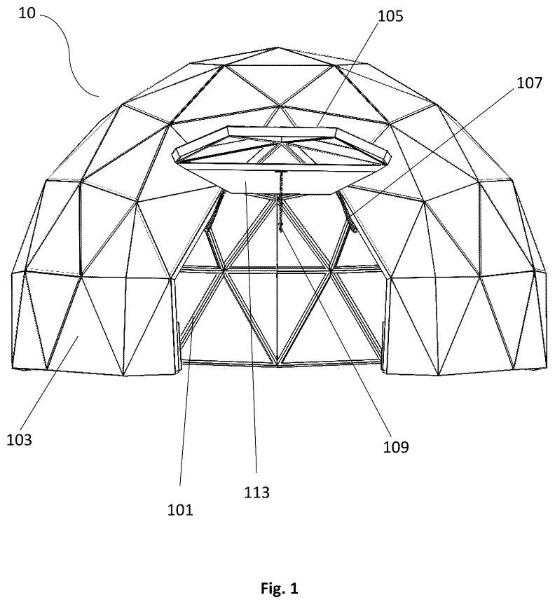

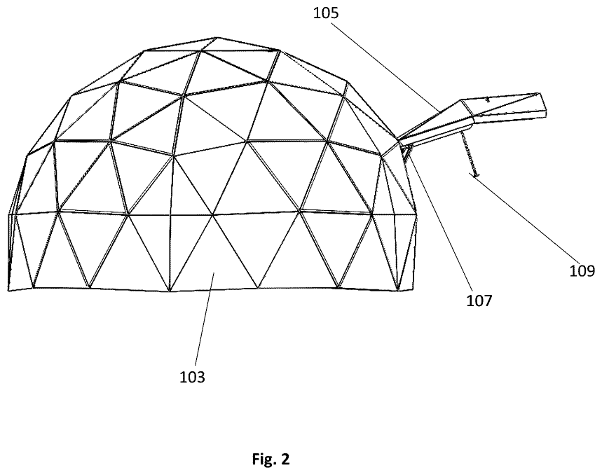

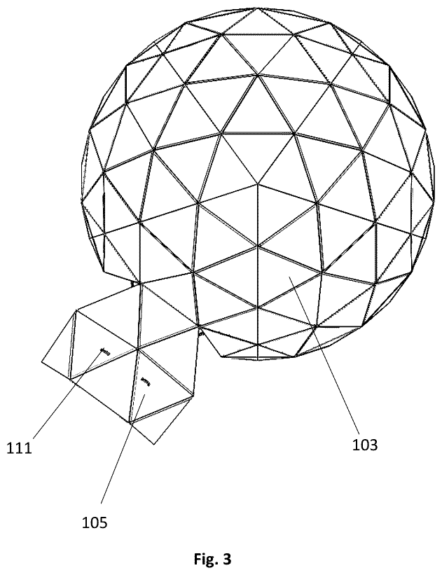

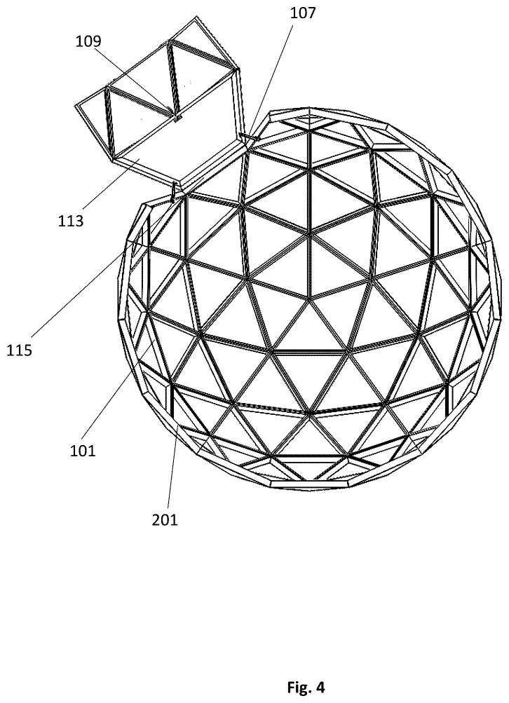

Referring now to FIGS. 1-6 the apparatus of the present disclosure relates to a shelter apparatus and method of assembly thereof for protecting a user for exterior condition. The invention can alternately be described as a geodesic safety structure configured to provide shelter for occupants from tornado-like conditions. The apparatus 10 of the present disclosure can be generally adapted to provide shelter to occupants during conditions of extreme wind, including but not limited to shear winds and tornados. In some exemplary embodiments, the apparatus can be comprised of an arcuate structure in the form of a geodesic dome. The device dome shape can be specifically adapted to be comprised of a plurality of sections 11 that can be assembled together to form a cohesive structure. The dome configuration can provide better dispersion of wind shear as well as a stronger structure to withstand impacts and potential debris that may fall onto or impact the structure.

A shelter structure of the present disclosure can include an interior support frame 101. The interior support frame 101 can be comprised of one or more support members 200. The support members 200 can be comprised of any suitable material, including but not limited to a metal, alloy, carbon fiber, concrete, precast concrete, polymer, or any other suitable material. The support member can have an exterior surface and an interior surface. A plurality of support members 200 can be constructed into one or more geometrical configurations to form a support section 210. In one exemplary embodiment, the support sections 210 can be configured to form a triangle configuration. In other exemplary embodiments, the support members 200 can be configured in other geometric configurations including but not limited to a pentagon or hexagon configuration among others.

The shelter apparatus 10 of the present disclosure can further include one or more panels 103 that can be coupled to the exterior surface of the interior support frame 101. In some exemplary embodiments, a singular panel 103 can be formed around the exterior surface of the support frame 101. In other exemplary embodiments, the shelter apparatus can include a plurality of panels 103 that correspond to the configuration of the individual support section 210 or alternatively for the entire building section 11. The panel or panels 103 can be constructed from any suitable material, including but not limited to fiberglass, carbon fiber, polymer, plastic, metal, alloys, amount other materials. The panels can be similarly coupled together to form a weather resistant barrier from the exterior of the apparatus to the interior of the apparatus.

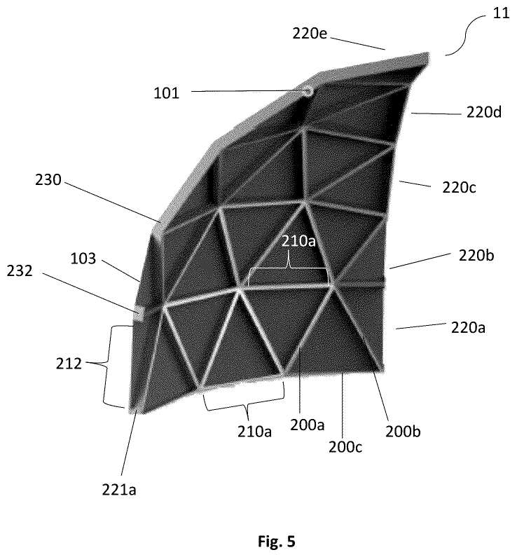

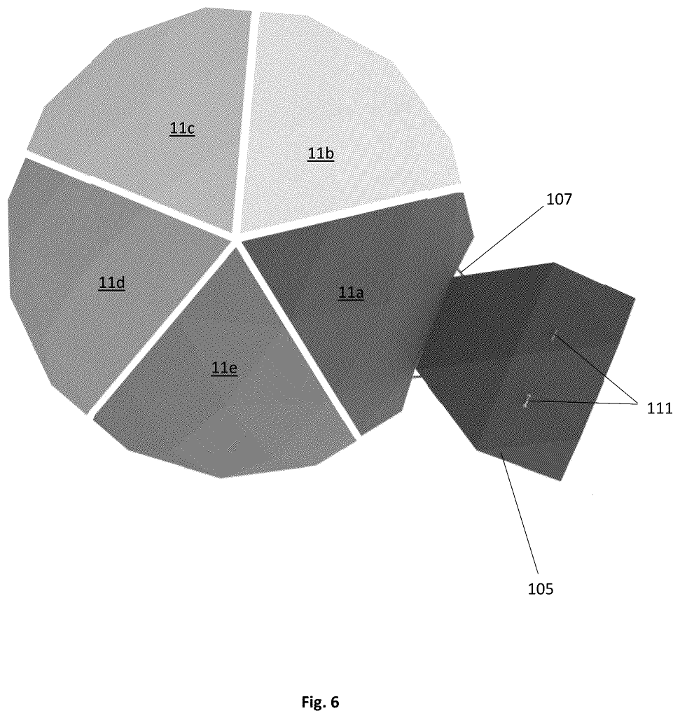

As shown in FIGS. 5-6, the shelter apparatus of the present disclosure can be constructed from one or more individual building sections 11. By having a plurality of building sections 11, the apparatus 10 can be constructed in a first location and easily transported and constructed in a second location in various sections. The exterior panels 103 can be formed to cover the entire exterior side of the frame 101 of a building section 11. This configuration can allow for the support members 200 to be pre-fabricated to form the frame section 101 and allow for various types of exterior panels 103 to be used to form the exterior surface of the building structure. A user can then construct the shelter on-site with minimal tools and cost. In other exemplary embodiments, the frame 101 can be fully constructed in a singular section.

The support frame 101 for an individual building section 11 can be constructed using any suitable method including welding the support members 200 into the desired configuration. Similarly, the support sections can be coupled to each other using any suitable means including but not limited to fasteners or welding. In some exemplary embodiments, a plurality of support sections 210 can be pre-fabricated and the coupled together to form a building section 11. Alternatively, the individual support members 200 can be removably coupled to one another using any suitable fastener. In some exemplary embodiments, the apparatus 10 can be constructed from a plurality of rows 220 that can be constructed from a plurality of support section 210. The apparatus can include a first row 220a of support sections 210, a second row 220b of support section 210, a third row 220c of support section 210, and a fourth row 220d of support sections 210. The top edge of a first row 220a can be coupled to the bottom edge of the second row 220d using any suitable fastening means, including but not limited to fasteners, welding, adhesives, among other fastening means. Similarly, the remaining rows can be coupled on top of each other until the final row 220d forms a top of dome portion. Alternatively, a separate top dome portion 220e may be coupled to the top edge of the final row 220d. The bottom surface 201 of the first row 221a can include one or more mounting points to allow for the support frame 101 to be coupled to the ground. In some exemplary embodiments, the frame 101 can be fastened to a foundation or ground using anchor bolts or fasteners. A pre-determined location can be designated having one or more anchor locations to couple the apparatus 10 to the foundation.

In one exemplary embodiment, a support section 210 can be comprised of a first support member 200a, a second support member 200b, and a third support member 200c. The exterior panels 103 can be coupled to the interior support frame 101. The individual support section 210 can be coupled to one another or alternatively share one or more support members 200 of the adjacent support section 210 as shown in FIG. 5. A first support section 210a can optionally share at least one of the support members 200 of the second support section 210b. This can reduce material costs as well as reduce assembly costs. In some exemplary embodiments, a building section 11 can include a plurality of rows of support sections 210. The triangular configuration of the support sections 210 can allow for a structurally rigid and strong structure to withstand heavy weight loads and force. The dome configuration similarly provides great structural integrity.

In some exemplary embodiments having a plurality of building sections 11, the individual building section 11 can include a side frame portion 230 that can be formed from a plurality of support members 210 or alternatively formed separately from the support members to form the exterior edges of the building section 11. The building sections 11 can be comprised of the triangular support sections 210. Generally, the triangular support sections 210 can be uniform. In some exemplary embodiments, a partial support section 212 along the side frame portions 230 or edge of the building section 11 may be only about half of a primary support section 210 to allow for an easier construction between the building sections 11. The partial support sections 212 may be necessary in the various rows depending upon the size of the apparatus 10 and the support sections 210. The side frame portions 230 can include one or more mounting points 232 that can correspond to a respective mounting point 232 of another building section 11. These mounting points 230 can be used to couple the various building sections 11 together when assembling the apparatus 10. Any suitable fastening means can be used to couple together the various building sections 11.

In one exemplary embodiment of the apparatus 10 of the present disclosure, the apparatus 10 is provided in a plurality of distinct sections 11a,b,c,d,e that can be fastened together as shown in FIG. 6. In one exemplary embodiment, the apparatus 10 of the present disclosure can include five building sections. One of the building sections 11 of the plurality of sections can have a door portion 105. The door portion 105 can similarly be constructed from one or more support members 200 and can have a similar support section structure 210 to correspond to the support sections 210 of the other building sections. The door portion 105 can be configured to be integrated into the building section 11 of the apparatus 10. The door portion 105 can function as a structural portion of the building section 11 of which it is incorporated.

The door portion 105 can be hingedly mounted to the frame structure 101 and can include at least one hinge deployment means 107 to enable easy opening and closing of the door section. A hinge deployment means 107 can including any suitable apparatus such as a pneumatic or hydraulic piston. The deployment means 107 can have a first end and a second end where the first end is coupled to a portion of the frame of the building and the second is coupled to a portion of the frame of the door portion 105. The door 105 can be configured to open from a first position to a second position. In some exemplary embodiments, the door 105 can swing out while in other embodiments the door can swing inward into the structure.

The door can be incorporated as part of the structure of a building section 11a as shown in FIG. 6, while the remaining building sections 11b,c,d,e may not include a door section. The dimensions and configuration of each of the building sections 11 can be uniform to allow for ease of construction. The door 105 can additionally have one or more exterior handles 111 to allow for easy use in opening the door portion 105. An interior handle or pull 109 can be coupled to the interior of the door portion 105 to allow a user to easily close the door when inside the interior portion. The door portion 105 can further include a locking mechanism that can ensure the door will remain in a closed position when in use. The apparatus can further include one or more interior panels 113 that can be coupled to the interior surface of the frame 101. The interior panels can utilize any suitable materials. In some exemplary embodiments, the interior panels can have insulative properties to provide insulation to the interior of the structure from the exterior elements.

In one exemplary embodiment of the building apparatus of the present disclosure can include an interior steel frame 101 and outer fiberglass panels 103 that can be secured to the interior frame 101. The apparatus can be configured for assembly in multiple environments and locations, including, but not limited to, a basement, a ground surface, or a concrete slab. The apparatus can be specifically designed to allow for easy ingress during adverse weather conditions and is configured to specifically withstand the extreme weight and force from a tornado. The apparatus of the present disclosure can specifically be made from materials to withstand extreme weights and wind speeds of a tornado or other hostile weather environments. The exterior panels can take any suitable color or transparency to best fit the surrounding area.

While the invention has been described above in terms of specific embodiments, it is to be understood that the invention is not limited to these disclosed embodiments. Upon reading the teachings of this disclosure many modifications and other embodiments of the invention will come to mind of those skilled in the art to which this invention pertains, and which are intended to be and are covered by both this disclosure and the appended claims. It is indeed intended that the scope of the invention should be determined by proper interpretation and construction of the appended claims and their legal equivalents, as understood by those of skill in the art relying upon the disclosure in this specification and the attached drawings.

What is claimed is:

1. A storm shelter apparatus, comprising:
a plurality of building sections, wherein each section comprises:
a frame portion having a plurality of support members, wherein the support members are configured into a plurality of triangular support sections, wherein one or more exterior panel members are coupled to an exterior surface of frame portion, wherein the frame portion further includes a plurality of mounting plates to couple the an adjoining sections of the plurality of building sections together and one or more base plates to couple the storm shelter building system to the ground; and
a pivotable door hingedly coupled to at least one of the plurality of building sections, wherein the pivotable door can be moved from a first position to a second position.

2. The storm shelter apparatus of claim 1, wherein the pivotable door is comprised of a plurality of support members, wherein the support members are configured into a plurality of triangular support section.

3. The storm shelter apparatus of claim 2, wherein the pivotable door forms a portion of one of the plurality of building sections.

4. The storm shelter apparatus of claim 3, wherein a hydraulic hinge is coupled to the pivotable door to assist in moving the pivotable door from the first position to the second position.

5. The storm shelter apparatus of claim 4, wherein the plurality of building sections and the pivotable door form a geodesic dome configuration when the door is in the second position.

6. The storm shelter apparatus of claim 5, wherein one or more interior panels are coupled to the interior surface of the support sections.

7. The storm shelter apparatus of claim 1, wherein comprising five building sections, wherein each building section is comprised of at least four rows of triangular support sections configured to form a curved building section.

8. The storm shelter apparatus of claim 7, further comprising at least one interior panel.

9. The storm shelter apparatus of claim 8, wherein the interior panel has an insulative property configured to insulate an interior area of the apparatus.

10. The storm shelter of the apparatus of claim 9, further comprising an interior door handle and an exterior door handle.

11. The storm shelter apparatus of claim 10, wherein the pivotable door is a structural portion of the building section.

12. A storm shelter apparatus, comprising:
a plurality of building sections, wherein each building section comprises:
a frame portion having a plurality of triangular support sections, wherein the support sections are comprised of support members, wherein one or more exterior panel members are coupled to an exterior surface of the frame portion, wherein the frame portion further includes a plurality of mounting plates to couple the an adjoining sections of the plurality of building sections together, and one or more base plates to couple the storm shelter building system to the ground; and
a pivotable door hingedly coupled to at least one of the plurality of building sections, wherein the pivotable door can be moved from a first position to a second position, wherein the pivotable door provides structural support to the building section.
